(19) United States
(12) Patent Application Publication
(10) Pub. No.: US 2008/0104233 A1
(43) Pub. Date: May 1, 2008

(54) NETWORK COMMUNICATION METHOD AND APPARATUS

(75) Inventors: Richard James Smith, Bristol (GB); Jonathan Griffin, Bristol (GB); Andrew Patrick Norman, Bristol (GB); Richard Brown, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 11/872,534

(22) Filed: Oct. 15, 2007

(30) Foreign Application Priority Data
Oct. 31, 2006 (GB) 0621562.8

(51) Int. Cl. G06F 15/173; G06F 15/16

(52) U.S. Cl. 709/224; 709/230

(57) ABSTRACT

A networked computing platform implements an opportunistic data communication method. The computing platform creates, at the instigation of at least one application executing on the platform, data packets for transmission over a network. The packets are created using a hierarchy of programs (‘stack’) implementing a corresponding hierarchical suite of network protocols each associated with a corresponding protocol data unit (PDU) that comprises protocol-control information for that protocol. The opportunistic communication method involves the platform waiting for creation of a packet to be instigated and thereupon setting a parameter in protocol-control information of the packet to a value indicative of a characteristic of the computing platform, this characteristic being one unconnected with functioning of the network protocols. A network monitoring method and a network administration method are also disclosed.

### BACKGROUND TO THE INVENTION

1. Field of the Invention

The majority of commercial and government enterprises operate and administer (or have administered, on their behalf, by a contracted third party) significant Information Technology networks made up, inter alia, of large numbers of client computers, some servers and the necessary networking infrastructure or ‘furniture’, such as routers, hubs and switches to enable the required interconnection for data to be transmitted. In spite of the significant, negative security ramifications, such organisations predominantly endorse a policy of uniformity or neo-uniformity of client operating systems, which has the effect of rendering the entire network susceptible to any attack based on a vulnerability in the chosen operating system. The negative impact of such policies are exacerbated where the selected operating system is one which is a de facto standard whose complexity is, at least in part, a result a market need for backward compatibility with its (many) forebears, especially where each ancestor was wrought with vulnerabilities to exploitation by malicious code. Quite apart from the innate vulnerabilities which tend to be present in such systems as a result of their lengthy heritage, their very pervasiveness ensures that significant effort is continually expended in developing malicious code to exploit such vulnerabilities. Further, the patching of such vulnerabilities, it is now agreed by most experts, provides opportunities for writers of malicious code. Firstly, the release of patches draws awareness to the existence of vulnerabilities on un-patched computers that may previously not have been apparent; secondly, the complexity and size of operating systems means that new patches are likely to introduce unforeseen vulnerabilities in the course of remedying ones which are known.

Nonetheless, it is not anticipated that there will be any imminent change in such policies. It becomes, therefore, increasingly important for any network administrator to be able to establish the precise nature of the client computing systems within his or her network, which clients have applied which patches and so on. This way, an administrator can at least have an understanding of the extent of any vulnerabilities within his network so that, when an attack occurs, decisions regarding remedial or preventative action can be well-informed.

2. Description of Related Art

Knowledge regarding the configuration of client computers within a network can, classically, be obtained in one of three ways. The first, and most simple way is simply to keep a log, whether manual or automated to some degree, of the various operating systems and patch levels of various computers; for example by one or more of BIOS identity, IP address, or MAC address. This log can be kept by the administrator and updated by an administrator when patches are applied by him; alternatively, were patches are applied by a user, the user can be required to update the log. Another way is to engage in active monitoring of systems by ‘sniffing’ at them, that is to say interrogating them in predetermined ways and, depending upon the responses to one or more interrogations, inferring certain characteristics about them. This process, often called ‘active fingerprinting’, provides relatively accurate and up-to-date information. A third way is passively to monitor systems, i.e. simply monitoring the outgoing networking packets and, from the content of those packets, inferring the characteristics of their provenant system; this process is known as ‘passive fingerprinting’. Passive fingerprinting works by comparing subtle differences in the default values used by each network stack (typically a TCP/IP stack) whereby it is possible to determine which stack implementation, and hence which operating system, the target machine is using. This is due to the unique way in which each developer has interpreted the ambiguous sections of certain RFCs. “P0f”, which is currently the most reliable passive fingerprinting network scanner available on general release, has a number of tests that look for variations in certain header fields of the network traffic including IP time-to-live, IP don't fragment bit, the initial TCP window size, the size of a SYS packet, and which TCP options are used.

### SUMMARY OF THE INVENTION

According to a first aspect of the present invention, there is provided an opportunistic data communication method for use on a networked computing platform that creates, at the instigation of at least one application executing on the platform, data packets for transmission over a network, these packets being created using a hierarchy of programs (‘stack’) implementing a corresponding hierarchical suite of network protocols each associated with a corresponding protocol data unit (PDU) that comprises protocol-control information for that protocol; the method comprising:
waiting for creation of a packet to be instigated by said at least one application, and
thereupon setting a parameter in protocol-control information of the packet to a value indicative of a characteristic of the computing platform, this characteristic being unconnected with functioning of the network protocols.

Waiting for creation of a packet to be instigated can involve a periodic check for packet creation activity but will more usually not require any action as packet creation activity itself can be used to trigger the setting of the aforesaid protocol-control-information parameter.

According to a second aspect of the present invention, there is provided a computing platform comprising a hierarchy of programs (stack) for implementing a hierarchical suite of networking protocols to create, at the instigation of at least one application executing on the platform, data packets for transmission over a network, the platform further comprising an additional program adapted to cooperate with the stack to provide to the stack, parameter-value data indicative of a characteristic of the computing platform that is unconnected with functioning of the networking protocols; a particular program of the stack being adapted to set a parameter in protocol-control information of a packet being created by the stack at the instigation of a said application, to a value corresponding to said parameter-value data.

According to a third aspect of the present invention, there is provided a method of administering a network comprising:
configuring a computing platform within the network to include, within protocol-control information of data packets created by that computing platform at the instigation of at least one application executing on the platform, a parameter value which signifies a characteristic of the platform that is unconnected with functioning of network protocols used for packet creation;
transmitting from the computing platform data packets including that parameter value;
detecting, from the data packets, the parameter value and an address of the computing platform from which they were transmitted; and
inferring, from the parameter value, the characteristic of the computing platform at the detected address.

### BRIEF DESCRIPTION OF DRAWINGS

Embodiments of the invention will now be described, by way of example, with reference to the accompanying drawings, in which:

FIG. 1 is a schematic representation of a client computing platform;

FIG. 2 is a schematic detail of the platform of FIG. 1;

FIGS. 3A and 3B are schematic representations of a data packet;

FIG. 4 is a schematic representation of a first embodiment of client computing platform according the present invention;

FIG. 5 is a table illustrating mappings of distinctive parameters to patch level and OS version;

FIG. 6 is a table illustrating fields of an IP header;

FIG. 7 is a schematic representation of a part of a network on which embodiments of the present invention may be implemented; and

FIG. 8 is a schematic representation of an alternative embodiment of client computing platform according the present.

### DESCRIPTION OF PREFERRED EMBODIMENTS

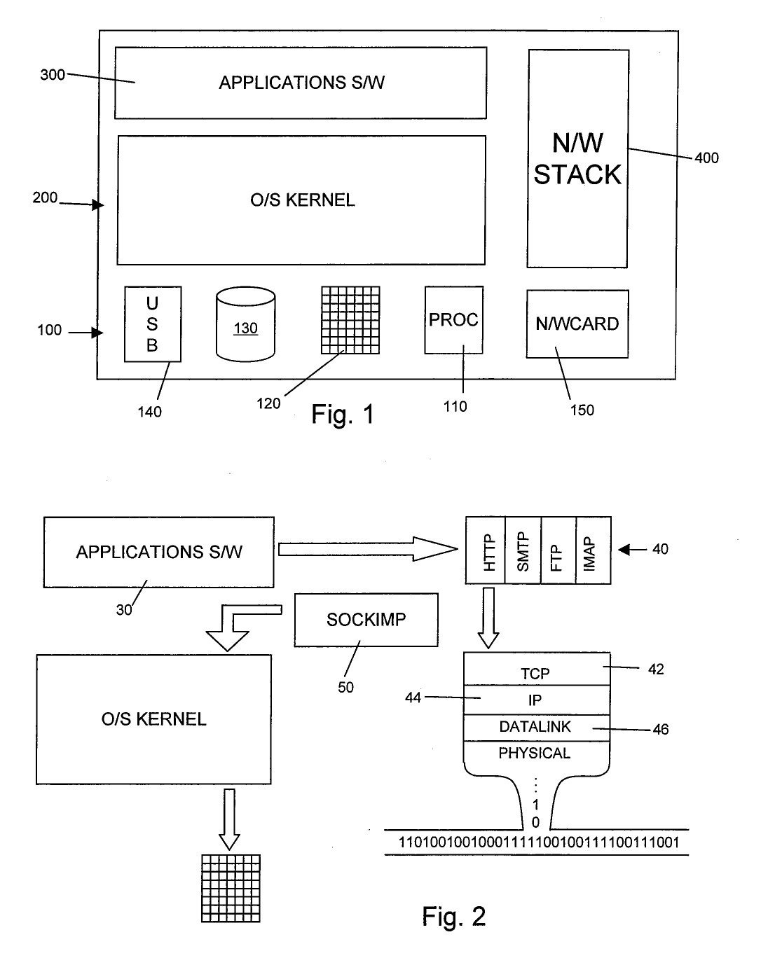

Referring now to FIG. 1, a typical client computer can be thought of as comprising three classes of functional elements. The first class of elements is the hardware 100, which includes the processor 110, memory 120, storage disc 130, peripheral USB port 140 and network card 150. The second class of functional element is the operating system kernel 200, which is a low-level software program whose function is to provide access to common core services of the computer, including task scheduling, memory allocation and management, disk access allocation and management, and access to hardware devices such as the processor and network card. The operating system performs these tasks predominantly on behalf of one of a variety of applications programs 30, such as a word processor and email client, which form the third class of functional elements in the computer.

A further functional element of the computer is a hierarchy 400 of programs which implement a hierarchy of networking protocols. The program hierarchy 400 is known in the art as a ‘stack’ of programs in though, somewhat confusingly, stack is also a term used frequently to refer to the hierarchy of protocols. For clarity, in this specification, the hierarchy of protocols will be referred to as a ‘suite’ and the hierarchy of programs which implement the protocols as a stack; the stack being made up of individual stack programs whose function is to implement the corresponding layer in the network suite. Classically, the standard networking protocol suite is acknowledged to have seven layers. In the present illustrated example, however, not all of these will be referred to explicitly since doing so would add nothing to an exposition or comprehension of the present invention. Moreover, it is to be emphasised that, although the present embodiments are illustrated in connection with a protocol suite containing TCP/IP, this is not essential and that the present invention is equally applicable to any hierarchy of networking protocols whose specification permits its implementation.

In the following, the terms “protocol data unit” and “protocol-control information” are used; both these terms will be well understood by persons skilled in the art and their usage is in accordance with the definitions given in US Federal Standard 1037C (“Telecommunications: Glossary of Telecommunication Terms”):
protocol data unit (PDU): In layered systems, a unit of data that is specified in a protocol of a given layer and that consists of protocol-control information of the given layer and possibly user data of that layer.
protocol-control information: . . . . For layered systems, information exchanged between entities of a given layer, via the service provided by the next lower layer, to coordinate their joint operation.

Referring now additionally to FIG. 2, the salient layers of the network stack are illustrated, labelled by the particular protocol which they are implementing. The highest level of the protocol suite implemented by the network stack 400 is the application layer 40 (not to be confused with the applications 30 that use this layer). As with other layers, this layer has a number of alternative protocols, such as HTTP and SMTP, each of which implemented by a different and corresponding stack program. In the present example the stack program will implement HTTP, for example on behalf of a web browser applications program 30. Below the application layer is the transport layer 42 and one example of a transport protocol is Transmission Control Protocol (‘TCP’), whose function includes the assignment of source and destination logical port numbers to the transmitted data so that the two communicating computers can identify the data sent as pertaining to a particular communications session and applications protocol. The transport layer sits on top of the network layer 44, one example of which is Internet Protocol which, inter alia, assigns a source and destination IP address to the transmitted data. Below the IP layer is the datalink layer 46, in this example, Ethernet, one of whose functions is the assignment of a physical address of the network card of the computer to the transmitted data. The network stack 400 thus includes a hierarchy of programs which implement specific examples of the various generic protocol layers and is known per se.

Associated with the network stack, though not forming a part of it, is a socket implementation program 50, which, upon detecting a call instigating the creation of a packet from an stack program at the applications protocol level, performs a number of functions, including instructing the Operating System to allocate a socket—i.e. designated memory space to which data received in the course of the communication about to be conducted, may be written. In the case of outgoing data, each of the programs in the stack has the function of creating a protocol data unit (PDU) necessary to conform with the implementation of its respective protocol, which PDU is then passed down to the stack program below, whereupon it is nested within a PDU created by that stack program. This process continues all the way down the stack until a complete Ethernet packet or Frame is created, containing nested within it, all of the PDUs created by the higher stack programs. At each level in the stack, the particular PDU being created by the stack program concerned will include, in addition to the PDU received from above, protocol control information regarding the functioning of the protocol being implemented by the stack program.

In the case of incoming data the reverse process takes place, each stack program receiving and processes the PDUs created by its counterpart program in a remote computer, passing all remaining PDUs to the program above it.

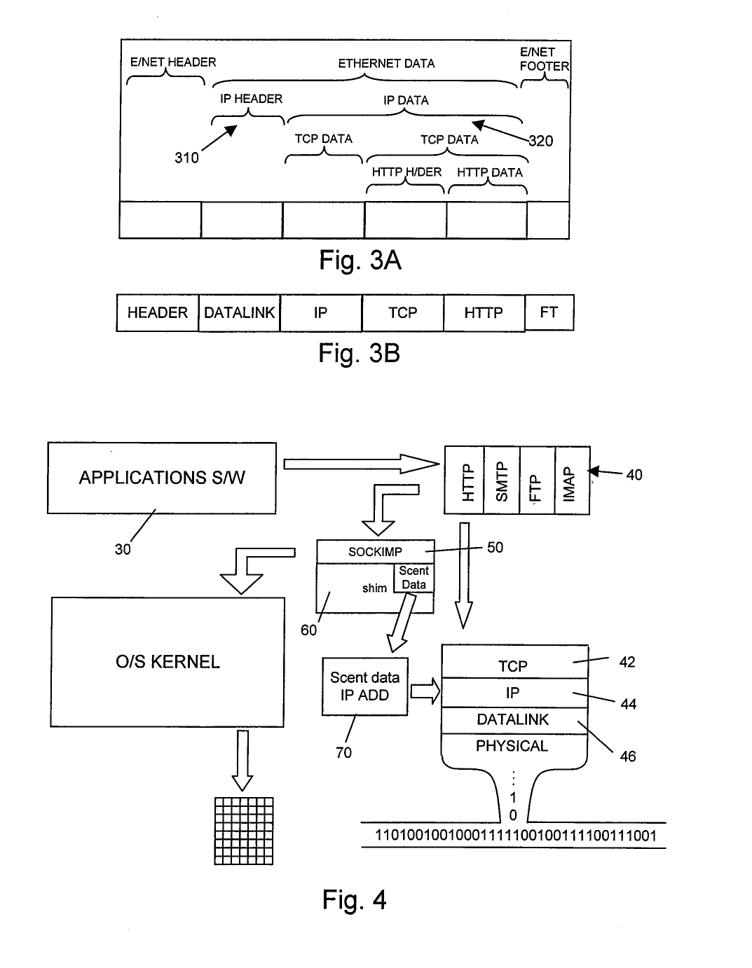

The format and content the various PDUs and of the packets which are made out of them are generally specified in standards established by the Internet Engineering Task Force (IETF), known as RFCs. In accordance with the standards, and as already indicated, each of the individual PDUs have certain features in common. Thus, referring now to FIG. 3A, each PDU includes protocol-control information usually in the form of a header section (but sometimes also including a footer section), and a data section, these being referenced 310 and 320 respectively for the PDU created by IP layer. The header contains at least a source address and destination address. The data for each field, other than that of the PDUs produced by the stack program implementing the application layer protocols, is constituted by the entire PDU passed down (visually ‘up’ in FIG. 3A) from the stack program immediately above it (visually ‘below’ it in FIG. 3A). Thus, the application layer PDUs constitute the user data for the PDU produced in the transport layer; the transport layer PDU (which has, as its user data, the PDU from the application layer) is the user data for the PDU produced in the networking layer and so on. This sequential nesting of the PDU from one stack program to the next all the way down the stack 400 results, ultimately, in a nested set of PDUs which are, ultimately, framed in an Ethernet frame, or packet, illustrated in FIG. 3B. Thus it can be seen that the format and configuration of data packets is prescribed to a particular degree by standards.

As will be appreciated by persons skilled in the art, FIG. 3 and the related description is simplified to the extent that is does not cover all potential complications such as possibility of a lower layer needing to fragment segments passed down to it from the layer above, in order to provide data fragments small enough to fit within the size of PDU produced by the lower layer. Furthermore, some PDUs may be sent for protocol control purposes only in which cases no user data will be present in the PDUs.

Within the scope of network protocol standards, there usually remains some latitude for PDUs to be constituted in a singular manner. In particular, within the protocol-control information (header) of an IP PDU, there is an ‘OPTIONS’ field which provides, under current standards, up to 38 bytes of data to be configured entirely as any user pleases. The OPTIONS field can, therefore, be thought of as a parameter with user-set values—the size of the field simply permitting a very wide range of user-set values. The OPTIONS field was designed to carry security information or routing data but is typically rarely used. Most IP options consist of three subfields; option type, option length, and option data. RFC 3692 defines a number of IP option types that can be used for experimentation and RFC 1812 specifies that unrecognised IP option types must be passed through routers unchanged.

Embodiments of the present invention exploit the ability to create PDUs segments in a manner to provide for the marking or ‘scenting’ of outgoing packets from a particular computer to signify, inter alia, the identity of the operating system of the platform from which they have been issued. Such ‘scents’ can be monitored easily by elements of network infrastructure such as routers, providing administrators with easy and reliable data regarding the status and configuration of client computers on the network.

Referring now to FIG. 4, when a client computer is first configured for use by an administrator, a ‘shim’ program 60 is applied to it, integrated into the socket implementation program 50. The shim program has a specific role, namely to configure data of a PDU created by a stack program so that a particular parameter of the protocol-control information of that PDU has a value signifying a characteristic of the operating system (or other feature unconnected with the functioning of the network protocols) of the client computer from which a packet containing it is issued. To this end, the shim has recorded within it the parameter-value data (herein the ‘scent data’) specifying the value to be used for the aforesaid particular parameter of the concerned PDU's protocol-control information; in the present example, the particular parameter is a parameter of the OPTIONS field of the PDU created by the IP layer stack program.

As already noted, the value of the ‘scent data’ indicates a characteristic of the operating system (or other feature unconnected with the functioning of the network protocols) of the client computer. By way of example, the value specified by the ‘scent data’ can be used to indicate both the operating system type and the patch version carried for that operating system.

One manner in which the shim 60 carries out its role is as follows. When an applications program seeks to instigate a connection with a remote computer, say in this instance a web browser requests the provision of a web page from a remote server, the corresponding applications-level stack program, here the program implementing the HTTP protocol, generates calls to the socket implementation program 50, causing the operating system to assign a socket. Simultaneously, the data generated within the stack at the HTTP layer—in this example, a GET request—is passed sequentially down the stack so that each layer can add the elements necessary to implement the corresponding layer of the networking protocol suite. For a given program in the stack to configure its PDU, it may be necessary for it to receive external data. As an example, in the case of stack program implementing Internet Protocol, the IP address of the client computer issuing the HTTP GET request is required. Since the IP address is typically assigned by a Dynamic Host Control Protocol (DHCP) server each time a client computer connects to a TCP/IP network, the IP address may change from one networking session to another. Due to the potentially dynamic nature of the IP address, this is clearly data which cannot be embedded permanently within the network stack, but nonetheless must be included within the relevant data segment. Data such as the IP address is, therefore, stored within a data register 70, directly accessible by the IP stack program, and whose contents are automatically updated each time a new IP address is assigned.

In the present example, the shim 60 uses this data register 70 as a route to send the ‘scent data’ to the stack program implementing Internet Protocol. Thus, once the various programs in the stack are brought into operation, the data values which are stored in the data register 70 and which are to be included within data fields in the header of the IP PDU are retrieved by the IP stack program and placed into the appropriate fields of the PDU generated by that program. In particular, the ‘scent data’ that indicates the operating system and patching status of the client PC, is used to set a value in the OPTIONS field of the IP header.

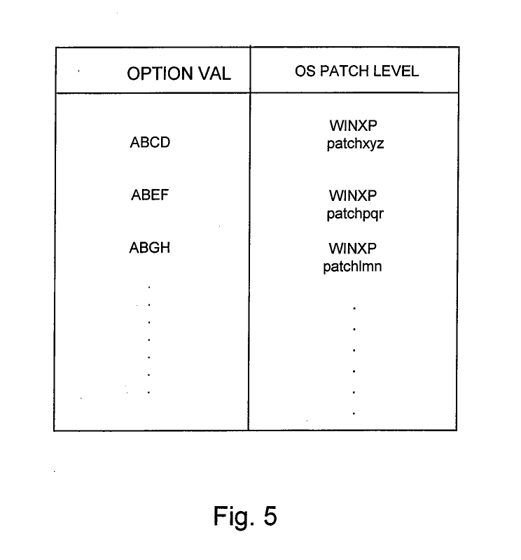

FIG. 5 indicates an example mapping between the value of the ‘scent data’ and the operating system identity and patch level of the client computer. In this example, the first two characters map to the Operating system and the second two to the patch version for that OS. Further and more extensive mappings may be employed to signify further characteristics as required, given that 38 bytes of data are available for use.

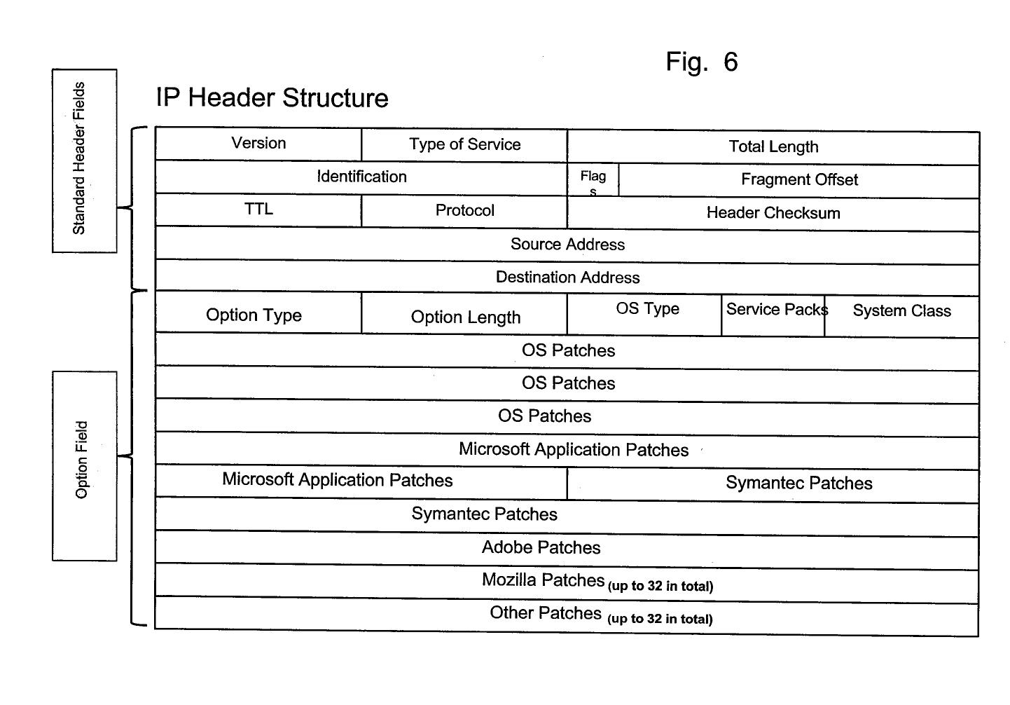

In an alternative and preferred mapping, the ‘scent data’ is a bit-level encoding that defines which operating system is running, which service packs are installed, which patches have been installed, which major applications are installed, and which application patches are installed; FIG. 6 illustrates an example usage of the OPTIONS field of the IP header to carry the foregoing information. To save space, common patches can be combined together into security groups with unique identifiers to avoid needing to specify every patch individually.

Whatever mapping is used between the ‘scent data’ value and the platform characteristic being indicated, the network administrator maintains a copy of this mapping.

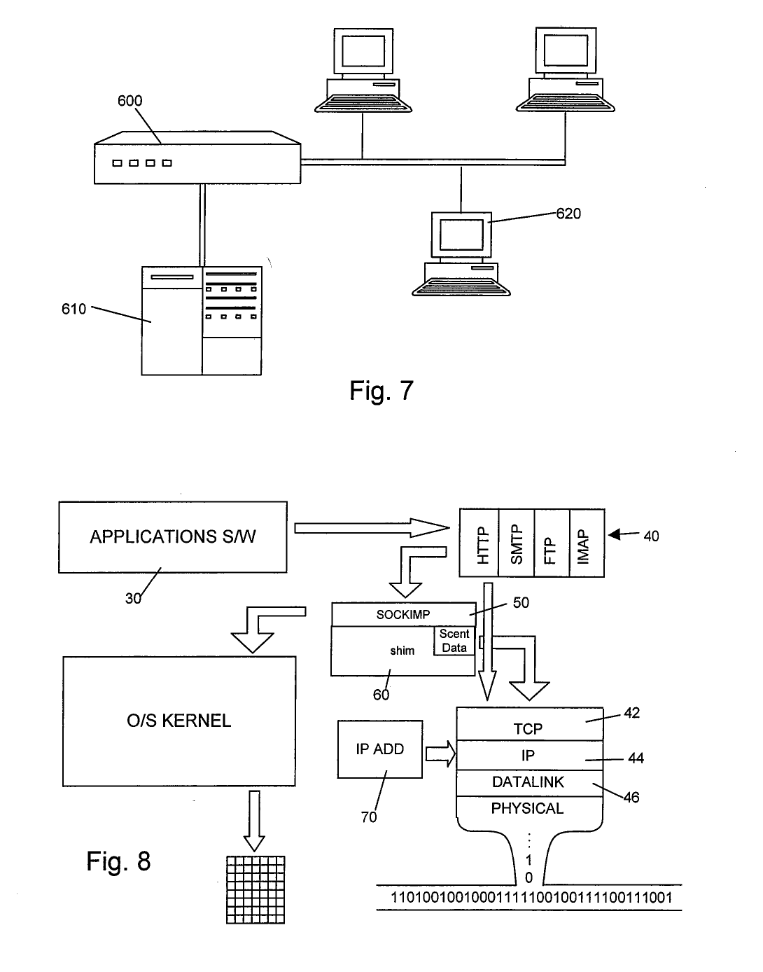

Referring to FIG. 7, the data values from the OPTIONS field can be captured easily and routinely at a network router 600, for example, which routes packets on the basis of IP address, from a server 610 to a client computer 620. The captured values can be returned to the server 610 and using the mapping, an administrator can obtain valuable administrative information. Firstly, it can be determined whether, and if so to what extent, a client machine is running either an intrinsically vulnerable operating system or is carrying a patching status which is not current. With this information, an administrator may then either chose to enforce remedial patching and/or upgrade of the operating system. Alternatively, and in the case where remedial action by a user is required, the administrator may elect simply to send a message to the user of the client computer that patching is required and that, until patching has been performed, the client's services will be limited or degraded in some respects—for example by denying all packets with particular IP or MAC addresses certain services, or relatively slow routing of packets; this acting as an incentive to the user to perform the appropriate remedial action.

In the embodiment of FIG. 4, the ‘scent data’ was introduced into the network stack directly at the IP program level via a data register. It is also possible, however, to introduce the necessary data ‘vertically’ into the stack, in conjunction with the PDU received from the application-level program (for example, the HTTP-implementing program). Referring now to the alternative embodiment of FIG. 8, the shim 60, rather than operating to store the ‘scent data’ in the data register 70 which retains the IP address, introduces the ‘scent data’ into the TCP stack program at the same time as the HTTP PDU. This is achieved by calling a function present in the TCP stack program which operates to pass data to the IP stack program; this function is duly called by the shim 60 so that the data to be inserted into the OPTIONS field is passed to the IP stack program. Once this data reaches the IP stack program, it is recorded in the OPTIONS field in the IP data PDU as previously.

Because, in the examples described above where the ‘scent data’ is intended to indicate the current operating system and patch level of the client computer any update to the client computing platform that modifies these features requires a corresponding update to the ‘scent data’. Accordingly, each patch that is applied is accompanied by a corresponding update to the shim program 60, to cause an update to the ‘scent data’.

As alluded to previously, the present invention has been described by exemplary reference to TCP/IP. It is nonetheless equally applicable to any hierarchy of networking protocols. Further, the various modifications are not intended to be limited in applicability to the embodiments in connection with which they were first described and, unless stated expressly otherwise, are intended for general application across all illustrated embodiments.

It is to be understood that while the various protocols of a protocol suite have been described as implemented by respective programs of a program stack, the code of two or more of such programs can be integrated into a single code package.

Furthermore it will be appreciated that the ‘scent data’ value can be inserted in all or only some packets created by the network program stack; in the latter case, packets used for carrying the ‘scent’ data value can be selected in a variety of ways, for example every nth packet could be used or packets can be randomly used. However, the selection of which packets are to be used to carry the ‘scent data’ value is independent of the application giving rise to the creation of a packet by the stack.

Information about characteristic(s) of the computing platform can be spread across:
the values of multiple protocol-control information parameters in the same packet, and/or
the values of the same protocol-control information parameter in multiple packets.

The scenting of the data packets is effectively an opportunistic data communication mechanism that waits for packets to be created at the instigation of application programs running on a platform and then uses these packets to carry data by setting one (or more) parameter values in the protocol-control information of the nested protocol data units. As used herein, the term “opportunistic” means that the scenting mechanism is not responsible for the initiation of packet creation either directly or by acting via one of the application programs and must therefore wait for an iapplication to initiate packet creation. Of course, this waiting for creation of a packet to be instigated will generally not require any action as the packet creation activity itself triggers the action required for setting of the aforesaid protocol-control-information parameter; however, it would be possible for the ‘waiting’ to involve a periodic check for packet creation activity.

The computing platform running the above-described opportunistic communications method is not limited to a user client computer such as a PC, but can be any device on the network that runs a network stack and has sufficient and appropriate resources to add scents into network packets as they are created. The packets may be packets that serve to pass on received packets but under different lower-level protocols to that employed by the received packets. Furthermore, the applications 30 are to be understood to include any entity making use of the network stack to send data over the network.

Although in the foregoing, the computing platform characteristic indicated in the scent data have been exampled by operating system identity and patch data, other characteristics can be alternatively or additionally indicated. For example, the scent data can indicate security settings or information about the user of the computing platform (such information is to be understood as being a characteristic of the computing platform for the purposes of the present specification)

1. An opportunistic data communication method for use on a networked computing platform that creates, at the instigation of at least one application executing on the platform, data packets for transmission over a network, these packets being created using a hierarchy of programs (‘stack’) implementing a corresponding hierarchical suite of network protocols each associated with a corresponding protocol data unit (PDU) that comprises protocol-control information for that protocol; the method comprising:
waiting for creation of a packet to be instigated by a said at least one application, and
thereupon setting a parameter in protocol-control information of the packet to a value indicative of a characteristic of the computing platform, this characteristic being one unconnected with functioning of the network protocols.

2. A method according to claim 1, wherein each program in the stack that lies between two other stack programs is operative to incorporate a protocol data unit received from a program above it, into its own protocol data unit which it then passes to a program below; the protocol-control-information parameter value indicative of said characteristic of the computing platform being set by a said stack program below the top of the stack on the basis of parameter-value data received from higher up the stack.

3. A method according to claim 2, further comprising introducing the parameter-value data into a program of the stack for transmission down the stack to the program that sets the protocol-control-information parameter value indicative of said characteristic of the computing platform.

4. A method according to claim 1, wherein each program in the stack that lies between two other stack programs is operative to incorporate a protocol data unit received from a program above it, into its own protocol data unit which it then passes to a program below; the protocol-control-information parameter value indicative of said characteristic of the computing platform being set by a said stack program which is below the top of the stack on the basis of parameter-value data introduced into the stack at the level of this program.

5. A method according to claim 4, wherein the stack has an associated data register for holding the parameter-value data for access by the program that sets the protocol-control-information parameter value indicative of said characteristic of the computing platform; the method further comprising storing the parameter-value data to the data register.

6. A method according to claim 1, wherein the stack program that sets the protocol-control-information parameter value indicative of said characteristic of the computing platform implements Internet Protocol.

7. A method according to claim 6, wherein the parameter is in an options field of the protocol-control information constituted by a header of the Internet Protocol.

8. A method according to claim 1, wherein said characteristic of the computing platform comprises at least one of operating system identity and patch level, the method further comprising mapping at least one of operating system identity and patch level to said value indicative of a characteristic of the computing platform.

9. A method of monitoring a network-connected computing platform, comprising:
carrying out the opportunistic communication method of claim 1 to transmit over the network from the computing platform data packets with a protocol-control information parameter set to a value indicative of a characteristic of the computing platform that is unconnected with functioning of the network protocols;
detecting the data packets on the network and determining the value of said protocol-control information.

10. A method according to claim 9, wherein said characteristic of the computing platform comprises at least one of operating system identity and patch level, the method further comprising:
at the computing platform, mapping at least one of operating system identity and patch level to said value indicative of a characteristic of the computing platform;
following said detecting of the data packets on the network and determining the value of said protocol-control information parameter value, mapping the determined value to at least one of the computing platform's patch status and operating system.

11. A method of administering a network, comprising:
carrying out the monitoring method of claim 9; and
providing different services or levels of service for the computing platform in dependence upon its monitored operating system and/or patch status.

12. A method according to claim 1, wherein information about said characteristic of the computing platform is spread across the values of multiple protocol-control information parameters in the same packet.

13. A method according to claim 1, wherein information about said characteristic of the computing platform is spread across values of the same protocol-control information parameter in multiple packets.

14. A method according to claim 1, wherein some only of the packets created by the stack have the value of a protocol-control information parameter set to indicate said characteristic of the computing platform.

15. A method according to claim 1, wherein said characteristic of the computing platform is a characteristic of a user of the computing platform.

16. A computing platform comprising a hierarchy of programs (stack) for implementing a hierarchical suite of networking protocols to create, at the instigation of at least one application executing on the platform, data packets for transmission over a network, the platform further comprising an additional program adapted to cooperate with the stack to provide to the stack parameter-value data indicative of a characteristic of the computing platform that is unconnected with functioning of the networking protocols; a particular program of the stack being adapted to set a parameter in protocol-control information of a packet being created by the stack at the instigation of a said application, to a value corresponding to said parameter-value data.

17. A computing platform according to claim 16, wherein the platform additionally comprises a data register associated with the stack and which the particular program can access, said additional program being adapted to store the parametric-value data to the data register.

18. A computing platform according to claim 16, wherein said particular program is below a top level of the stack, the additional program being adapted to call a function of a program higher up the stack than said particular program in order to pass the parameter-value data to the program with said function, this latter program being adapted to pass the parameter-value data down the stack to said particular program.

19. A method of administering a network comprising:
configuring a computing platform within the network to include, within protocol-control information of data packets created by that computing platform at the instigation of at least one application executing on the platform, a parameter value which signifies a characteristic of the platform that is unconnected with functioning of network protocols used for packet creation;
transmitting from the computing platform data packets including that parameter value;
detecting, from the data packets, the parameter value and an address of the computing platform from which they were transmitted; and
inferring, from the parameter value, the characteristic of the computing platform at the detected address.
